(19) United States
(12) Patent Application Publication
(10) Pub. No.: US 2004/0059615 A1
(43) Pub. Date: Mar. 25, 2004

(54) System and method for planning and executing an engineering change

(76) Inventors: Loralie A. Byrer, Auburn, WA (US); Paul P. Hebert, Crofton Bear, DE (US); Loren L. Loesell, Renton, WA (US); Harold A. Stowe, Tacoma, WA (US)

Correspondence Address: HARNESS, DICKEY & PIERCE, P.L.C., P.O. BOX 828, BLOOMFIELD HILLS, MI, 48303, US

(21) Appl. No.: 10/247,068

(22) Filed: Sep. 19, 2002

(51) Int. Cl. G06F 17/60

(52) U.S. Cl. 705/8

(57) ABSTRACT

A method for executing a six box process for implementing an engineering change using a web-base system. The method includes utilizing a process sequence template to develop an engineering change plan by mapping a plurality of interactions between a plurality of organizations impacted by the engineering change plan Additionally, the method include utilizing a tip sheets/design aids tool to review the engineering change plan by educating design organizations on at least one functional requirement that needs to be satisfied to generate a completed engineering change record (ECR). Furthermore, the method includes utilizing a system survey/metrics tool to understand errors that occur during a lifecycle of the six box process by gathering discrete engineering change error information, data resulting from the engineering change, and abstract perceptions of the engineering change throughout the lifecycle of the six box process.

### FIELD OF INVENTION

The invention relates generally to a process for planning and implementing engineering changes during the manufacture of a product. More specifically, the invention relates to mapping and communicating data interactions throughout a lifecycle of an engineering change implemented during manufacture of a product. Additionally, the invention relates to aids for communicating functional tips and feedback during a set of iterative steps of the lifecycle.

### BACKGROUND OF THE INVENTION

Ideas for improvement of a product often occur after development and manufacture of the product have begun. Generally, when these ideas for improvement occur an engineering change is proposed. The process of proposing and incorporating the engineering change for complex products involving numerous functional representatives is very involved, time consuming and often causes unnecessary feedback process errors, thereby adding to flow times and associated costs. Also, technical and non-technical errors can arise between designers and support disciplines, e.g. manufacturing, quality assurance, tooling, and data management, during the development and implementation of the change. These errors often necessitate reworks that add further unplanned flow time and costs.

Therefore, an objective of the present invention is to map and analyze engineering changes over the entire lifecycle of the change such that the typical iterative steps within the lifecycle are executed more efficiently. Mapping and analyzing the entire lifecycle of the change enables better identification of where process bottlenecks may occur due to inadequate communication and/or insufficient resources, e.g. people, tools and facilities. By improving the identification of process bottlenecks and their causes, it is possible to implement only those changes that efficiently improve throughput and cost of that critical process.

### BRIEF SUMMARY OF THE INVENTION

In a preferred embodiment of the present invention, a method is provided for identifying and executing complex engineering changes. The method includes developing an engineering change plan utilizing a process sequence template and reviewing the engineering change plan utilizing a tip sheets/design aids tool. Additionally, the method includes implementing the engineering change plan and utilizing a system survey/metrics tool to gather discrete engineering change error information, data resulting from the engineering change and abstract perceptions of the engineering change during a lifecycle of the engineering change.

In another preferred embodiment of the present invention, a system is provided for executing a six box process for implementing an engineering change. The system includes a process sequence template utilized to develop an engineering change plan, a tip sheets/design aids tool utilized to review the engineering change plan, and a system survey/metrics tool utilized to gather information during a lifecycle of the six box process.

In yet another embodiment of the present invention, a method is provided for executing a six box process for implementing an engineering change using a web-base system. The web-based system includes at least one client system, at least one database, and a server system coupled to the client system and the database. The method includes utilizing a process sequence template to develop an engineering change plan by mapping a plurality of interactions between a plurality of organizations impacted by the engineering change plan Additionally, the method includes utilizing a tip sheets/design aids tool to review the engineering change plan by educating design organizations on at least one functional requirement that needs to be satisfied to generate a completed engineering change record (ECR). Furthermore, the method includes utilizing a system survey/metrics tool to understand errors that occur during a lifecycle of the six box process by gathering discrete engineering change error information, data resulting from the engineering change, and abstract perceptions of the engineering change throughout the lifecycle of the six box process.

### BRIEF DESCRIPTION OF THE DRAWINGS

The present invention will become more fully understood from the detailed description and accompanying drawings, wherein;

FIG. 1 is a block diagram of a server system utilized in accordance with a preferred embodiment of the present invention;

FIG. 2 is a flow chart showing a six step process for implementing a 6+ box process, in accordance with the present invention;

FIG. 3 is a graphic representation of a Process Sequence Template tool utilized by the 6+ box process shown in FIG. 2;

FIG. 4 is a graphic representation of a Schedule Template tool utilized by the 6+ box process shown in FIG. 2;

FIG. 5 is a graphic representation of a Tip Sheets/Design Aids tool utilized by the 6+ box process shown in FIG. 2;

FIG. 6 is a graphic representation of a Training Module tool utilized by the 6+ box process shown in FIG. 2;

FIG. 7 is a graphic representation of a System Survey/Metrics tool utilized by the 6+ box process shown in FIG. 2; and

FIG. 8 is a flow chart describing the operational steps of the 6+ box process shown in FIG. 2.

### DETAILED DESCRIPTION OF THE INVENTION

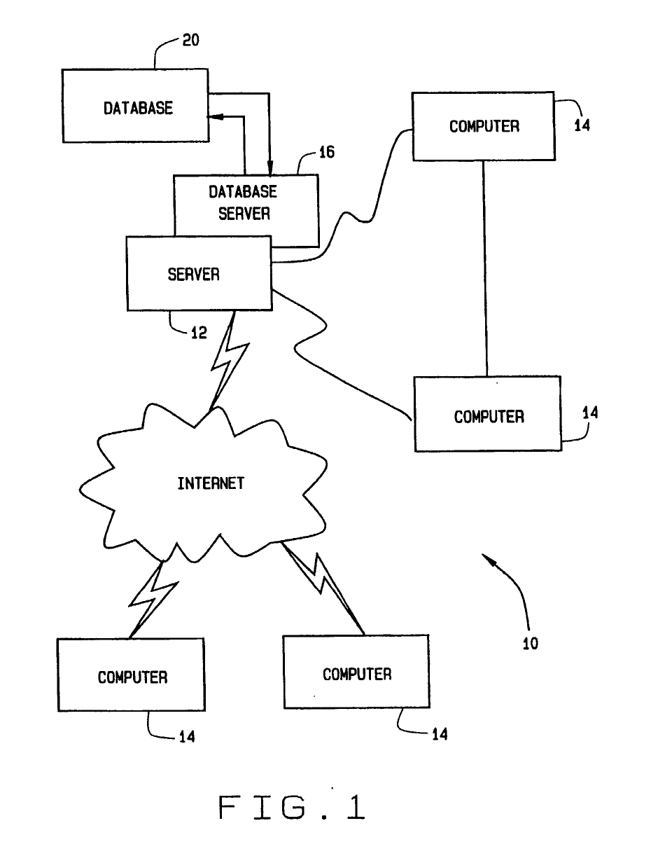

FIG. 1 is a block diagram of a server system 10 utilized in accordance with a preferred embodiment of the present invention. Server system 10 includes a server 12 and a plurality of client systems 14 connected to server 12. In one preferred embodiment, client systems 14 are computers connected to server 12 via a network such as a local area network (LAN). In another preferred embodiment, client systems 14 are computers including a web browser, such that server 12 is accessible to client systems 14 via the Internet. In this embodiment the client systems 14 are interconnected to the Internet through any suitable interface, for example, a LAN or a wide area network (WAN), dial-in-connections, cable modems and special high-speed ISDN lines. In which case, client systems 14 could be any type of electronic device capable of interconnecting to the Internet, including a web-based phone or other web-based connectable equipment.

A database server 16 is connected to a centralized database 20 containing web-site information, data, and graphics for implementing an engineering change process mapping and communications tool (ECPMC), as described below. The ECPMC web-site provides a place for centralizing information and data related to a plurality of engineering change processes. Database 20 can be accessed by potential users at any one of client systems 14 by logging on to server 12 through one of client systems 14. Thus, all authorized individuals such as managers, lead engineers and integrated product teams can access server 12 using one of the client systems 14. However, server system 10 has different access levels to control and monitor the security of the system. For example, access authorization can be based on job function or job titles, or management authority within the business entity. Additionally, server system 10 allows addition of new information, deletion of the current information, and editing of the current information stored in database 20. Administration and editing capabilities within server system 10 are restricted to ensure that only authorized individuals have access to modify or edit the information that exists in database 20.

The architectures of server system 10, as well as the various components of server system 10, are exemplary only. Other architectures and database arrangements are possible and can be utilized in connections with practicing the invention as described below.

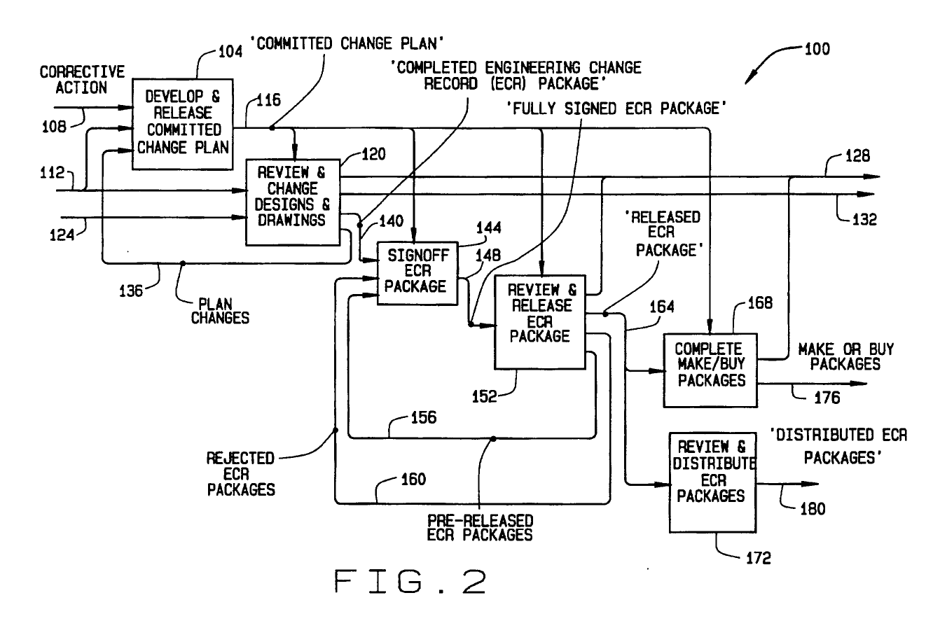

FIG. 2 is a flow chart 100 showing a six step process for implementing an engineering change, referred to herein as the 6+ box process. The 6+ box process represents the sequence of steps for the entire lifecycle of an engineering change from conception to being released as a ‘Make’ package to an internal factory and/or a ‘Buy’ package to suppliers/vendors. The first step of the 6+ box process is shown in FIG. 2 as a ‘Develop & Release Committed Change Plan’ process, or module 104. Module 104 requires an input 108 consisting of a corrective action. The corrective action is triggered any time a change is needed or proposed. For example, input 108 can be triggered by a request for an engineering change (RFEC) that is generated to implement an improvement to a present process, or by a rejection report from a factory floor generated when a process produces a flawed product. Also, input 108 can be triggered by a material discrepancy report from the factory floor generated when there is not enough material or the wrong material to manufacture a product, or by a newly conceived idea for a new process. Additionally, module 104 has other external inputs 112 that includes such things a vendor data and other functional data.

An output 116 of module 104 is a ‘Committed Change Plan’. The committed change plan is a set of documents delineating the proposed change plan, e.g. a plan for implementing the change and schedules for implementation. In one preferred embodiment, the ‘Develop & Release Committed Change Plan’ process, or module 104, incorporates the use of a process sequence template and a schedule template to streamline and improve the process of developing and releasing the committed change plan. The process sequence template and the schedule template are described in detail below. As shown in FIG. 2, the ‘Committed Change Plan’ output 116 is utilized as an input by other down stream processes, or modules.

The second step of the 6+ box process is shown in FIG. 2 as a ‘Review & Change Designs & Drawings’ process, or module 120. Module 120 uses as inputs the ‘Committed Change Plan’ 116, a design data input 124 and other external inputs 112. Design data represents the baseline configuration and analysis that exist prior to proposing the change, for example drawings, parts list, and test data, Other external inputs include vendor/supplier information that needs to be incorporated into the proposed updated design, or information in the form of requirement updates from a customer's use of the product in the field. At module 120 the committed change plan is reviewed by all the organizations, or disciplines, that are impacted by the change plan. During the ‘Review & Change Designs & Drawings’ module 120 at least one designer of the change plan interacts with specialists for all the different disciplines impacted. During this interaction the various disciplines begin to write and review instruments that would be needed or affected by the proposed engineering change, for example, documents, drawings, test data, designs and parts lists.

In one preferred embodiment, the designers utilize a tip sheet/design aids tool, described in detail below, to facilitate better communication and coordination of the interactions among the specialists of the different disciplines during the review. The ‘Review & Change Designs & Drawings’ module 120 can generate various outputs. For example, module 120 can generate an output 128 consisting of engineering reports and an output 132 consisting of requests for additional external inputs. Additionally, module 120 can generate a plan changes output 136 that is fed back into module 104. The plan changes output 136 is generated when review of the committed change plan by the impacted organizations generates a need to rework the change plan because the committed change plan is not workable. If review of the change plan by the impacted organizations is successfully completed, module 120 generates a ‘Completed Engineering Change Record (ECR) Package’ output 140 consisting of all the materials reviewed and updated in module 120, such as drawings, designs, instructions, and schedules.

The completed ECR package 140 is then input to the third step of the 6+ box process, shown in FIG. 2 as a ‘Signoff ECR Package’ process, or module 144. At module 144 the completed ECR package 140 is signed off on by all the impacted organizations signifying that all the impacted organizations agree that the completed ECR package 140 will implement the desired engineering change. Module 144 generates a ‘Fully Signed ECR Package’ output 148 that is input to the forth step of the 6+ box process, shown in FIG. 2 as a ‘Review & Release ECR Package’ process, or module 152.

The fully signed ECR package enters the ‘Review & Release’ process, or module 152, where a non-technical review is performed by a data management/data quality staff member to verify all the necessary contents of a release package are present. For example, the data management/data quality staff member verifies all the necessary signatures have been obtained, verifies affected drawing numbers are appropriately labeled and correspond to the correct change document, and verifies the parts list is correct in referring to the affected drawings. Once the package has passed all the checks, it is sent back as a pre-released ECR package 156 to module 144 for final approval by the originator of the change. After final approval no further changes can be made to the ECR and a master copy of the fully signed ECR package is stored in a secure environment accessible only by authorized persons. If all the necessary contents of the package are not present, the package is sent back to module 144 as a rejected ECR package 160, where the necessary contents are obtained.

Module 152 generates a ‘Released ECR Package’ output 164, which indicates that the signed ECR package is simultaneously input to the fifth and sixth steps of the 6+ box process. The fifth and sixth steps are respectively shown in FIG. 2 as a ‘Complete Make/Buy Packages’ process, or module 168, and a ‘Review & Distribute ECR Package’ process, or module 172. At module 168 the released ECR package is utilized to generate Make and/or Buy packages that are released at output 176 to down stream groups such as an internal ‘Make’ packages factory operations group and/or to ‘Buy’ packages suppliers/vendors. At module 172 engineering instruction data contained in the released ECR package is reviewed and routed, at output 180, to the factory floor or to a vendor/supplier's site. This involves data delivery of engineering instructions, e.g. drawings. parts list, and electronic datasets, that may arrive at the factory floor or vendor/supplier site before the ‘Make’ or ‘Buy’ packages. The complexity of the ‘Make’ or ‘Buy’ packages determines whether the engineering instructions arrives before or with the ‘Make’ or ‘Buy’ Packages.

The 6+ box process implements five tools that aid in avoiding bottlenecks that can cause flow time errors during the 6+ box process. In one preferred embodiment, the five tools are web-based, which makes implementation of the tools easier and more efficient. However, it should be recognized that the scope of the invention should not be limited to web-based implementation. The five tools can be implemented in a non-web-based manner and remain within the spirit and scope of the invention.

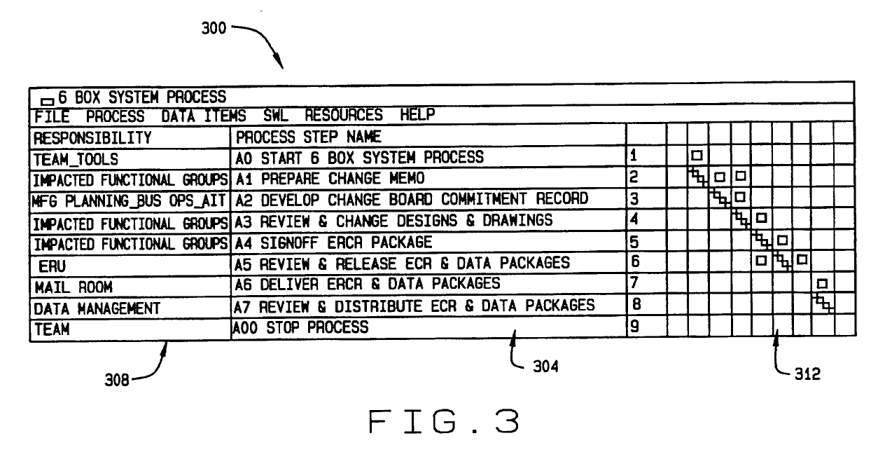

FIG. 3 is a graphic representation of a process sequence template 300. The process sequence template 300 is a tool utilized during the ‘Develop & Release Committee Change Plan’ process, module 104, of the 6+ box process (shown in FIG. 2). The process sequence template 300 is used to simplify and expedite development of the committed change plan 116 (shown in FIG. 2). The process sequence template 300 is the product of a Constructing Processes Around Data (CPAD) system that maps the interactions that occur across all the different disciplines/organizations that are impacted by the 6+ box process and creates a data-driven process in accordance with a process disclosed in U.S. Pat. No. 6,141,776, entitled Data-Driven Process Generator, issued Oct. 31, 2000, herein incorporated by reference in its entirety.

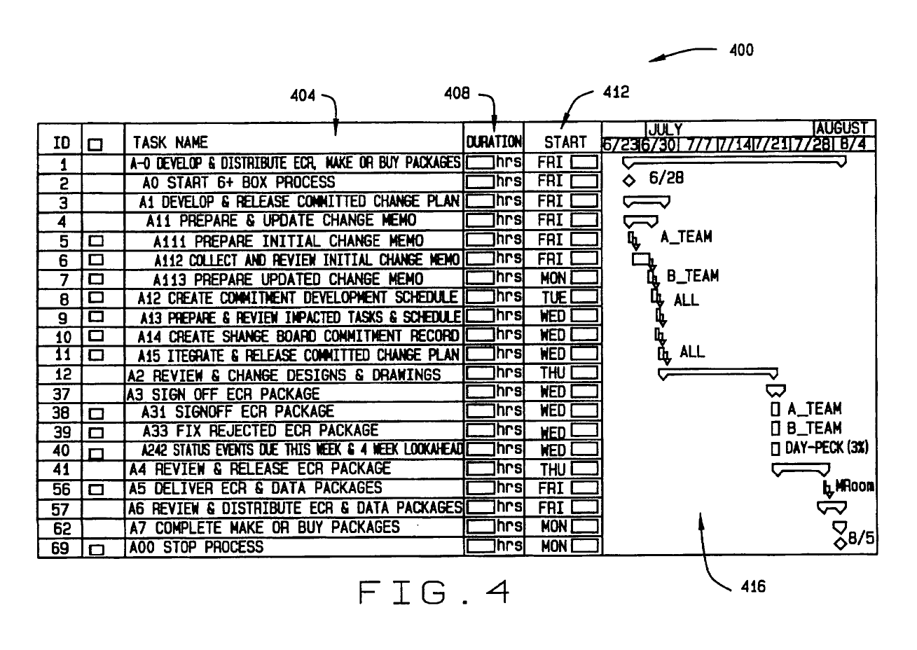

The process sequence template 300 includes a list of generic 6+ box change process steps 304, a list of organizations 308 that are responsible for executing a related step, and an input/output section 312 that shows the respective inputs and outputs of each step properly sequenced to deliver the outputs of the 6+ box process. The process sequence template 300 is tailored to every ‘instance’ of a change being planned in module 104. The engineer responsible for the change opens a file using the CPAD tool then adds/or removes affected steps, inputs, and outputs. He then uses the analysis capability of CPAD to determine where the iterative cycles, parallel steps, sequential steps, and key outputs are within the 6+ box change process. This information is then used by the schedule template described below in reference to FIG. 4.

FIG. 4 is a graphic representation of a schedule template 400. Schedule template 400 is a tool also utilized during the ‘Develop & Release Committed Change Plan’ process, module 104, of the 6+ box process (shown in FIG. 2). The schedule template 400 is created from the process sequence template 300 (shown in FIG. 3) and is used by engineering to plan and coordinate a schedule based on the mapped interactions between the various organizations impacted by the change proposed in the committed change plan 116 (shown in FIG. 2). The schedule template 400 includes a task name column 404 that sets forth steps that need to occur in the proposed change process. The steps are listed in the task name column 404 in the order the steps should occur in accordance with the sequence of processes as established by the preceding process sequence template 300 (shown in FIG. 3). Additionally, the schedule template 400 includes a duration column 408 where the duration of each step is indicated, and a start column 412 that indicates a projected start date of each task listed in the task name column 404. Furthermore, the schedule template 400 includes a graphical timeline section 416 that graphically shows a lifecycle timeline of the change as well as the timelines and interrelation of each of the change process steps listed in the task name column 404. It is envisioned that schedule template 400 could include other information such as what organizations are going to be impacted by the proposed change process.

More specifically, the schedule template 400 is a generic file created in schedule software, such as MSProject®, using the process sequence file from CPAD. The schedule template 400 is then modified by the engineering change originator to add corrected durations, along with edited resource quantities, e.g. people, tools and facilities. Other calculations such as a critical path analyses are performed using the schedule template 400. When completed, the schedule template generates a schedule file representing a flow schedule for all the remaining steps in the 6+ box process. Occasionally changes to the schedule may be required after it is released, and if so, it can be easily updated.

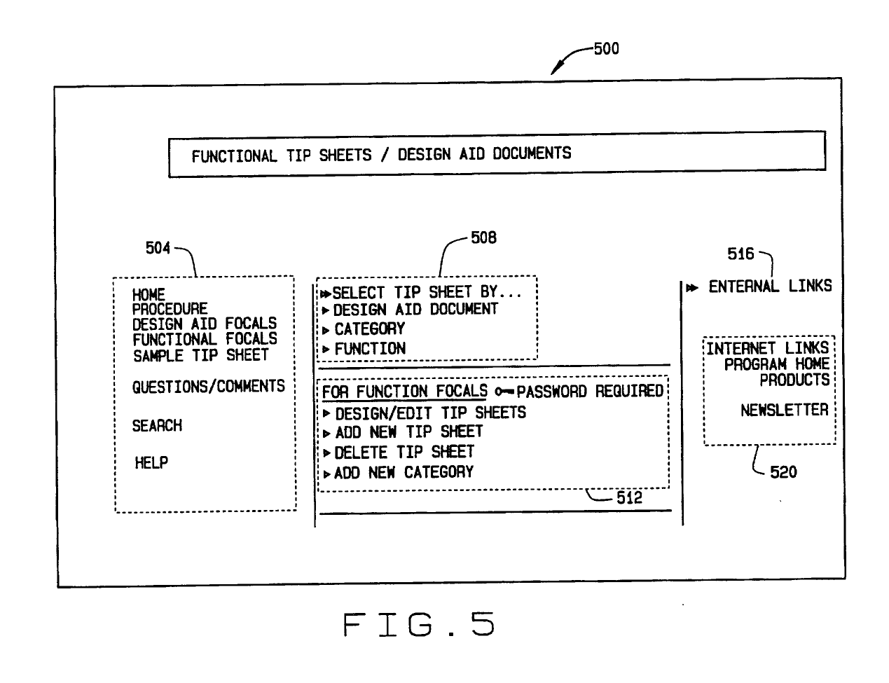

FIG. 5 is a graphical representation of a first page of a tip sheets/design aids tool 500 that is utilized during the ‘Review & Change Designs & Drawings’ process, module 120, of the 6+ box process (shown in FIG. 2). The tip sheets/design aids tool 500 educates users, such as designers and/or engineers, on the functional requirements that need to be met before routing the completed ECR package 140 (shown in FIG. 2) to the affected support disciplines for ‘signoff’ signatures. Specifically, the tip sheet/design aids tool 500 is used by the design organizations during the processing of a committed change plan 116 (shown in FIG. 2) and provides designers with data and information that needs to be considered to generate a completed ECR package that meets the requirements of the affected support disciplines. For example, the tip sheet/design aids tool 500 provides the designers with information and data pertaining to the interactions that will occur between all the different engineering and manufacturing disciplines during the 6+ box process. More specifically, the designers access the tip sheet/design aids tool 500 and read from it design content information that must be considered prior to outputting the completed ECR package 140 to the ‘Signoff ECR Package’ process 144 (shown in FIG. 2).

In a preferred embodiment, the tip sheets/design aids tool 500 is a web based tool wherein the first page includes a plurality of site navigation links 504 that assist a user in navigating the tip sheets/design aids tool 400. Additionally, the first page of the tip sheets/design aids tool 500 includes direct selection links 508 and functional links 512. The direct selections links 508 allow a user to access a tip sheet by title, category, or function. The functional links 512 are password protected and allow authorized user to perform maintenance task on the tip sheets/design aids tool 400, for example, edit tip sheets, add new tip sheets, delete old tip sheets, and add a new category of tip sheet. Furthermore, the first page of the tip sheet/design aids tool 500 includes external links 516 linked to sites outside of server system 10 (shown in FIG. 1), and internal links 520 that are linked to sites other than the tips sheets/design aids tool internal to server system 10.

More specifically, the tip sheets/design aids tool collects functional tips from all the support organizations, and assembles them into unique categories of design type problems. For example, in an aerospace program, the designers are organized into groups such as airframe, hydraulics, avionics, electrical, vehicle management systems, and fuel systems. The tip sheets created by the functional support disciplines such as stress, weights, manufacturing, and quality assurance, would be mapped to either a generic design aids document or to design aids documents unique to the different types of designer, for example airframe or hydraulics. These tips represent the requirements that support disciplines often view as overlooked by the deign community. The use of this tool greatly reduces the iterations between the designers and the affected functional support disciplines.

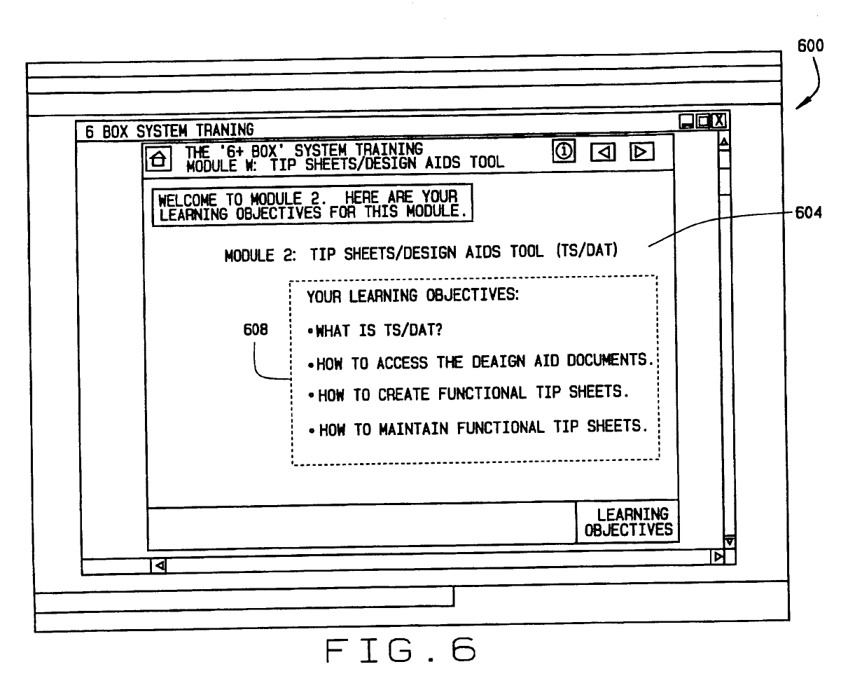

FIG. 6 is a graphic representation of a training module 600, which is a tool utilized during all stages of the 6+ box process (shown in FIG. 2). It is envisioned that the training module 600 comprises a plurality of self-paced web enabled training sub-modules that are designed to teach all the different discipline specialists necessary information pertaining to the process of planning and executing an engineering change. For example, the training module 600 includes sub-modules on how to create and utilize the process sequence template 300, the schedule template 400, and the tip sheet/design aids tool 500. For exemplary purposes FIG. 6 shows the training module 600 displaying a tip sheets/design aids tool sub-module 604. Each sub-module includes a plurality of learning objective links 608 that link the user to various training information relating to the respective training sub-module. The self-paced, web based training module 400 is available for use by anyone involved with the lifecycle of the typical engineering change.

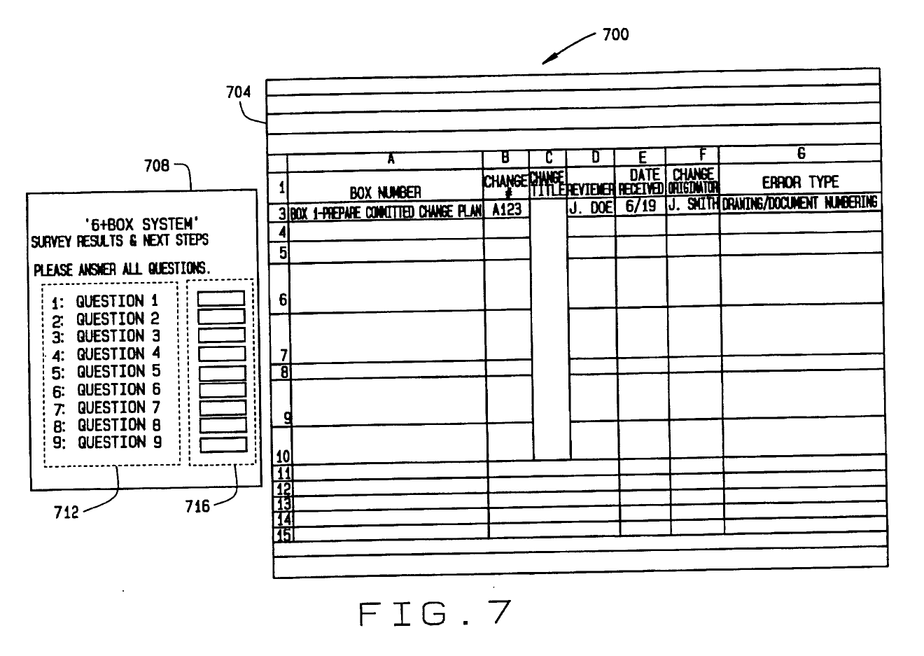

FIG. 7 is a graphic representation of a system survey/metrics tool 700 which is utilized during all stages of the 6+ box process (shown in FIG. 2). The system survey/metrics tool 700 comprises a plurality of web enabled questionnaires and surveys for gathering discrete error information, data and/or abstract perceptions of the engineering change process. The information and data gathered is utilized to understand the errors that occur during the 6+ box process lifecycle and what changes need to be made in order to make the 6+ box process more efficient. Specialists for the various disciplines impacted by the change can periodically provide information and data pertaining to such things as the types of errors that occur, the frequency of errors and flow times gathered during implementation of the ECR, via the 6+ box change process.

The system survey/metrics tool 700 includes at least one metrics questionnaire 704 that is completed frequently, for example daily, to monitor implementation of the ECR and expedite flow times. The metrics questionnaire gathers information such as the current 6+ box process step of the engineering change, a change identification number, a change title, the name of the reviewer for the related step, the date the ECR was received, the originator of the ECR and errors that have occurred at the related 6+ box process step. The information gathered using the metrics questionnaire 704 is fed back upstream in the 6+ box process where it is utilized to make corrections, which are then fed down stream in the 6+ box system as described above. Thus, creating an iterative process that constantly monitors and makes any necessary improvements to the implementation of an ECR using the 6+ box system.

Additionally, the system survey/metrics tool 700 includes at least one survey 708 that is periodically completed on a less frequent basis, for example once a month. Periodically the specialists complete a survey 708 by answering a plurality of questions 712 presented in the survey 708. In a preferred embodiment the survey 708 is web based and is automatically provided by the system survey/metrics tool 700. It is envisioned that the survey 708 include the questions 712 and corresponding interactive response fields 716 that provide the users with a list of predetermined responses to the question from which the user can choose an appropriate response. The survey collects information and data pertaining to the specialists' perception of the 6+ box change process and are utilized to improve the overall function of the 6+ box process.

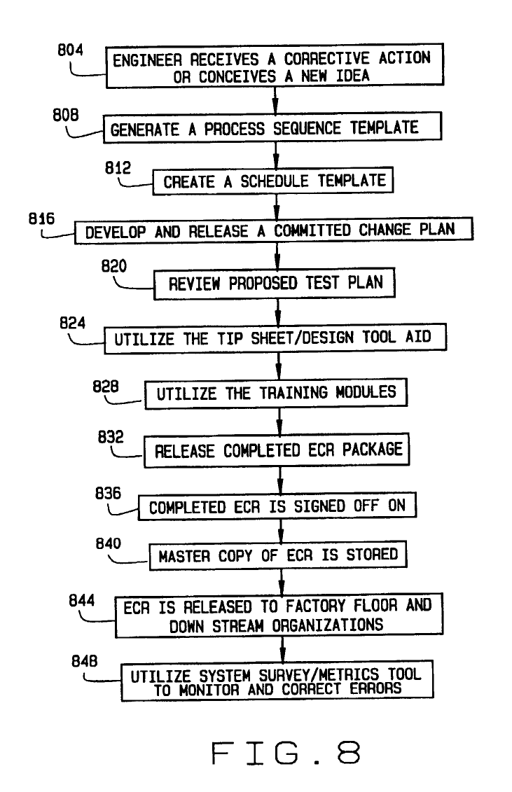

FIG. 8 is a flow chart 800 describing the operational steps of the 6+ box process (shown in FIG. 2). The 6+ box process is initiated when an engineer receives a corrective action from the factory floor or conceives a new idea for improving production of a product, as indicated at step 804. The engineer then begins to develop the change plan by utilizing the CPAD to generate a process sequence template 300 (shown in FIG. 3), as indicated at step 808. Using the process sequence template 300, the engineer creates a schedule template 400 (shown in FIG. 4), as indicated at step 812. Based on the information provided by the process sequence template 300 and the schedule template 400, the engineer develops and releases a committed change plan, as indicated at step 816. The committed change plan is then reviewed by a plurality of specialists from the various organizations that will be affected by the proposed change plan, and appropriate changes are made, as indicated at step 820. During the review and change process the various engineers and specialists utilize the tip sheet/design aid tool 500 (shown in FIG. 5) to organize and expedite the process, as indicated at step 824. Additionally, if needed, the training modules 600 (shown in FIG. 6) are utilized to educate and aid in the review and change process, as indicated at step 828.

The completed review and change process produces the completed ECR package, as indicated at step 832. The completed ECR package is signed off on by all the impacted organization, as indicated at step 836. A master copy of fully signed ECR package is then stored in a secure environment accessible only by authorized personnel, as indicated at step 840, and copies of the ECR are released down stream to the factory floor and to ‘Make’ and ‘Buy’ organizations, as indicated at step 844, where implementation of the ECR begins. During all phases of the 6+ box process errors in the process or in the implementation of ECR often occur. To monitor and correct such errors in a timely manner the system survey/metrics tool 700 (shown in FIG. 7) is utilized throughout the 6+ box process, as indicated at step 848.

Thus, the present invention maps and analyzes engineering changes over the entire lifecycle of the change such that the typical iterative steps within the lifecycle are executed more efficiently. Mapping and analyzing the entire lifecycle of the change enables better identification of where process bottlenecks may occur due to inadequate communication and/or insufficient resources, e.g. people, tools and facilities. By improving the identification of process bottlenecks and their causes, it is possible to implement only those changes that efficiently improve throughput and cost of that critical process.

While the invention has been described in terms of various specific embodiments, those skilled in the art will recognize that the invention can be practiced with modification within the spirit and scope of the claims.

What is claimed is:

1. A method for identifying and executing engineering changes, said method comprising:
a) developing an engineering change plan;
b) reviewing the engineering change plan utilizing a design aids tool;
c) implementing the engineering change plan; and
d) utilizing a system survey/metrics tool during at least one of the above mentioned steps to understand errors that occur during at least one of the above mentioned steps.

2. The method of claim 1, wherein the method further comprises utilizing a training module during at least one of steps a), b), and c).

3. The method of claim 2, wherein utilizing a training module comprises providing information pertaining to planning and executing the engineering change plan.

4. The method of claim 1, wherein developing the engineering change plan comprises using a process sequence template to expedite the development of the engineering change plan.

5. The method of claim 4, wherein using a process sequence template comprises mapping a plurality of interactions between a plurality of organizations impacted by the engineering change plan.

6. The method of claim 4, wherein developing the engineering change plan further comprises generating a schedule template based on the process sequence template.

7. The method of claim 6, wherein generating a schedule template comprises sequentially setting forth a plurality of engineering change plan steps that need to occur in accordance with a sequence of processes established by the process sequence template.

8. The method of claim 1, wherein reviewing the engineering change plan utilizing the design aids tool comprises educating design organizations on at least one functional requirement that needs to be satisfied to generate a completed engineering change record (ECR).

9. The method of claim 1, wherein utilizing the system survey/metrics tool comprises gathering at least one of the following: discrete engineering change error information, data resulting from the engineering change, and abstract perceptions of the engineering change.

10. A system for executing an engineering change process for identifying and implementing an engineering change, wherein said system comprises;
a process sequence template utilized to develop an engineering change plan;
a design aids tool utilized to review the engineering change plan; and
a system survey/metrics tool utilized to gather information during a lifecycle of the engineering change process.

11. The system of claim 10, wherein said process sequence template is adapted to expedite the development of the engineering change plan by mapping a plurality of interactions between a plurality of organizations impacted by the engineering change plan.

12. The system of claim 10, wherein said design aids tool is adapted to educate design organizations on at least one functional requirement that needs to be satisfied to generate a completed engineering change record (ECR).

13. The system of claim 10, wherein said system survey/metric tool is adapted to gather at least one of the following: discrete engineering change error information, data resulting from the engineering change, and abstract perceptions of the engineering change throughout the lifecycle of the engineering change process.

14. The system of claim 10, wherein said system further comprises a training module utilized to provide information pertaining to planning and executing said engineering change plan throughout the lifecycle of the engineering change process.

15. The system of claim 10, wherein said system further comprises a schedule template that is generated based on said process sequence template.

16. The system of claim 15, wherein said schedule template is adapted to sequentially set forth a plurality of engineering change plan steps that need to occur in accordance with a sequence of processes established by the process sequence template.

17. The system of claim 10 wherein said system further comprises a server system adapted to execute the engineering change process in a web-based manner.

18. A method for executing a engineering change process for identifying and implementing an engineering change using a web-base system including at least one client system, at least one database, and a server system coupled to the client system and the database, wherein said method comprises;
utilizing a process sequence template to develop an engineering change plan by mapping a plurality of interactions between a plurality of organizations impacted by the engineering change plan;
utilizing a design aids tool to review the engineering change plan by educating design organizations on at least one functional requirement that needs to be satisfied to generate a completed engineering change record (ECR); and
utilizing a system survey/metrics tool to understand errors that occur during a lifecycle of the engineering change process by gathering at least one of the following: discrete engineering change error information, data resulting from the engineering change, and abstract perceptions of the engineering change throughout the lifecycle of the engineering change process.

19. The method of claim 18, wherein the method further comprises utilizing a training module to provide information pertaining to planning and executing the engineering change plan throughout the lifecycle of the engineering change process.

20. The method of claim 18, wherein the method further comprises generating a schedule template based on the process sequence template such that the schedule template sets forth a plurality of engineering change plan steps that need to occur in accordance with a sequence of processes established by the process sequence template.

21. A computer-readable medium having encoded thereon instructions interpretable by a computer to instruct the computer to:
generate a engineering change plan schedule template based on process sequence data input to said computer, wherein said schedule template sets forth a plurality of steps for an engineering change plan used to implement an engineering change;
execute a design aids tool used to review said engineering change plan by providing at least one user with information pertaining to at least one functional requirement that needs to be satisfied to develop a completed engineering change record (ECR);
execute a training module used to provide instructional information to the user, wherein the instructional information pertains to planning and executing said engineering change plan throughout a lifecycle of said engineering change; and
execute a system survey/metrics tool utilizing data input to said computer pertaining to at least one of the following: discrete engineering change error information, data resulting from said engineering change, and abstract perceptions of said engineering change throughout the lifecycle of said engineering change, said system survey/metrics tool used by the user to understand errors that occur during the lifecycle of said engineering change.
